(19) United States
(12) Patent Application Publication
(10) Pub. No.: US 2005/0152613 A1
(43) Pub. Date: Jul. 14, 2005

(54) Image processing apparatus, image processing method and program product therefore

(75) Inventors: Masaru Okutsu, Kanagawa (JP); Yoshiharu Hibi, Kanagawa (JP); Atsushi Kitagawara, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/936,744

(22) Filed: Sep. 9, 2004

(30) Foreign Application Priority Data
Jan. 13, 2004 (JP) P2004-005278

(51) Int. Cl. G06K 9/00

(52) U.S. Cl. 382/254

(57) ABSTRACT

An image processing apparatus includes: characteristic parameter recognizing unit that recognizes a characteristic parameter of selected image data from the selected image data that is selected by a user; and an image processing unit that performs image processing on a plurality of image data individually using, as one of target values, the characteristic parameter of the selected image data that is recognized by the characteristic parameter recognizing unit.

### BACKGROUND OF THE INVENTION

1. Field of the Invention

The present invention relates to an image processing apparatus that processes a photographed image or the like and, more specifically, to an image processing apparatus that corrects a plurality of images.

2. Description of the Related Art

For example, in the printing market of using images for product handbills, advertisements, magazine articles, and the business market of producing exhibition and seminar materials, photographs for recording actual sites, snapshots of merchandise such as real estate properties and products, work of arranging, at prescribed regions, a plurality of images such as images (image data, digital images) taken by a digital camera (digital still camera: DSC) or read by a scanner and outputting (visualizing) an edited layout image is commonly performed. Conventionally, for example, images to be subjected to layout are taken by a cameraman and edited while they are adjusted individually as a user who is an image processing expert checks the states of the respective images. On the other hand, in recent years, with the rapid development and spread of photographing devices as typified by digital cameras and cellular phones and the advancement of network technologies such as the Internet, cases have increased that a plurality of images taken by general users in a distributed manner under different photographing conditions are put into a database.

Among background art techniques disclosed as patent publications is a technique of laying a plurality of images at designated regions by generating, for the respective images, rectangular regions that circumscribe additional images having a margin and arranging those according to prescribed arrangement rules (e.g., see JP-A-2003-101749 on pages 3-5 and FIG. 1). Another technique is disclosed in which to display a plurality of image data having indefinite image sizes on the screen in the form of multiple, easy-to-see images, the aspect ratios of read-in images are increased or decreased according to the ratios between the vertical dimensions (or horizontal dimensions) of display regions and those of the image data (e.g., see JP-A-2000-040142 on pages 4 and 5, and FIG. 1). Still another technique was proposed in which target image data in which the tone that is an element of the density, color, contrast, etc. of an image is optimized is acquired and parameters are set that cause gradations of the target image data corresponding to input gradations as subjects of correction to be made output gradations (e.g., see JP-A-2003-134341 on pages 6 and 7, and FIG. 1).

### SUMMARY OF THE INVENTION

If all of a plurality of image are taken under the same photographing conditions, it is possible to display a layout image that is easy to see. However, in the case of a plurality of images taken in different environments by different persons under different photographing conditions, a resulting layout image is not easy to see if the images are layout-displayed by using the technique of disclosed in JP-A-2003-101749 and JP-A-2000-040142 as it is. If a plurality of images of commodities are taken under different photographing conditions (e.g., photographing location, time, object position, object angle, illumination, and camera used), layout-displayed images become very poor because of subtle deviations in the size, position, and inclination, of the commodities. In addition to differences in such geometrical characteristic parameters, differences in characteristic parameters relating to image quality (image quality characteristic parameters) such as the brightness, color, gray balance, and a gradation representation are causes of poor layout-displayed images. Differences in the presence/absence of a background are also obstacles to comparison between a plurality of images and reference to each other. Conventionally, correction of image quality is performed manually for each image. However, particularly in the business market and the printing market in which layout images are required to be printed at high speed and chances that, for example, layout images are made available on the Web are increasing, the current situation that image correction relies on only manual work is not preferable.

In JP-A-2003-134341, target digital image data in which the tone is set to a target state is acquired and image processing is performed by using the target image data as a sample. However, the sense relating to optimization varies greatly from one person to another, an optimization result does not necessarily satisfies a particular user. In particular, where a plurality of images are displayed and output together, it may not be appropriate from the viewpoint of total balance to determine a tone target value of all images using predetermined target digital image data. Further, although the document JP-A-2003-134341 describes that the brightness, contrast, color balance, tone curve, and level correction are adjustable, easy-to-see images cannot be obtained only by the tone adjustment in the case where a plurality of images are layout-displayed together.

Still further, in the conventional image processing techniques including the technique of the cited reference 3, correction targets are predetermined by an apparatus and target values of various parameters are preset. It is therefore difficult to perform correction processing for a purpose unknown to the apparatus such as favorites of each user or to perform an image quality correction according to an unknown processing target. It would be possible to allow a user to set a processing target arbitrarily. However, sufficient experience is necessary for presetting saturation, brightness, or the like in the form a numerical value and it is difficult to associate an impression with a numerical value. Even if such work is done by a skilled person, a processing result will likely be incorrect.

The present invention has been made to solve the above technical problems, and one of objects of the invention is therefore to correct individual images automatically and thereby provide an attractive layout image or the like in outputting a plurality of images (image data) together.

Another object is to perform image processing in an apparatus according to an unknown processing target having no predetermined target value.

Still another object is to determine a correction amount on the basis of an image (i.e., selected image data) that gives a user an impression he or she desires.

A further object is to make it possible to determine a processing target on the basis of a plurality of images and thereby obtain a correction result according to a more correct standard.

According to a first aspect of the invention, there is provided an image processing apparatus including: characteristic parameter recognizing unit that recognizes a characteristic parameter of selected image data from the selected image data that is selected by a user; and an image processing unit that performs image processing on a plurality of image data individually using, as one of target values, the characteristic parameter of the selected image data that is recognized by the characteristic parameter recognizing unit.

According to a second aspect of the invention, there is provided an image processing apparatus including: a displaying unit that displays a plurality of image data in a listed form; a recognizing unit that recognizes, as selected image data, one or more of the plurality of image data displayed by the displaying unit; a characteristic parameter recognizing unit that recognizes a characteristic parameter of the selected image data from the selected image data that is recognized by the recognizing unit; and a setting unit that sets the characteristic parameter recognized by the characteristic parameter recognizing unit, as one of target values of image correction processing on the image data to be subjected to image processing.

According to a third aspect of the invention, there is provided an image processing method including: displaying on a user terminal a plurality of image data read out from a storing unit; recognizing a selection made by a user through the user terminal, the selection of image data as a target image data of image processing among the plurality of image data displayed; extracting a characteristic parameter of the selected image data; is setting a target value of the image processing to be performed on other image data on the basis of the extracted characteristic parameter; and storing the target value in a storage unit.

According to a fourth aspect of the invention, there is provided an image processing program product for causing a computer to execute procedures including: displaying on a user terminal a plurality of image data read out from a storing unit; recognizing a selection made by a user through the user terminal, the selection of image data as a target image data of image processing among the plurality of image data displayed: extracting a characteristic parameter of the selected image data; setting a target value of the image processing to be performed on other image data on the basis of the extracted characteristic parameter; and storing the target value in a storage unit.

### BRIEF DESCRIPTION OF THE DRAWINGS

The above objects and advantages of the present invention will become more apparent by describing in detail with reference to the accompanying drawings, wherein:

FIG. 1 shows the entire configuration of an exemplary image processing system according to an embodiment;

FIG. 2 shows functional block diagram for performing unified layout processing according to the embodiment;

FIG. 3 is a flowchart of a process that is mainly executed by a processing target determining section of an image processing server;

FIG. 4 shows a first exemplary user interface that presents a plurality of sample images to a user and causes the user to select one of those;

FIG. 5 shows a second exemplary user interface that presents a plurality of sample images to a user and causes the user to select one of those;

FIG. 6 shows a third exemplary user interface that presents a plurality of sample images to a user and causes the user to select one of those;

FIG. 7 is a flowchart of a processing target calculating process for a geometrical characteristic parameter.

FIG. 8 illustrate an example of calculation of a processing target;

FIG. 9 is a flowchart of a processing target calculating process for an image quality characteristic parameter;

FIG. 10 is a flowchart of a correction process for a geometrical characteristic parameter;

FIG. 11 is a flowchart of a correction process for an image quality characteristic parameter (image quality);

FIG. 12 is a flowchart of a process of calculation of processing targets from a background of a selected image(s) and a correction on a plurality of images;

FIG. 13 illustrates a step of extracting characteristic parameters of a selected image;

FIG. 14 illustrates processing that is performed on a subject image for correction using the characteristic parameters of the selected image that have been calculated as shown in FIG. 13;

FIG. 15 shows an example in which the unified layout processing according to the embodiment has not been performed; and

FIG. 16 shows an example in which the unified layout processing according to the embodiment has been performed.

### DETAILED DESCRIPTION OF THE PREFERRED EMBODIMENT

An embodiment of the present invention will be hereinafter described in detail with reference to the accompanying drawings.

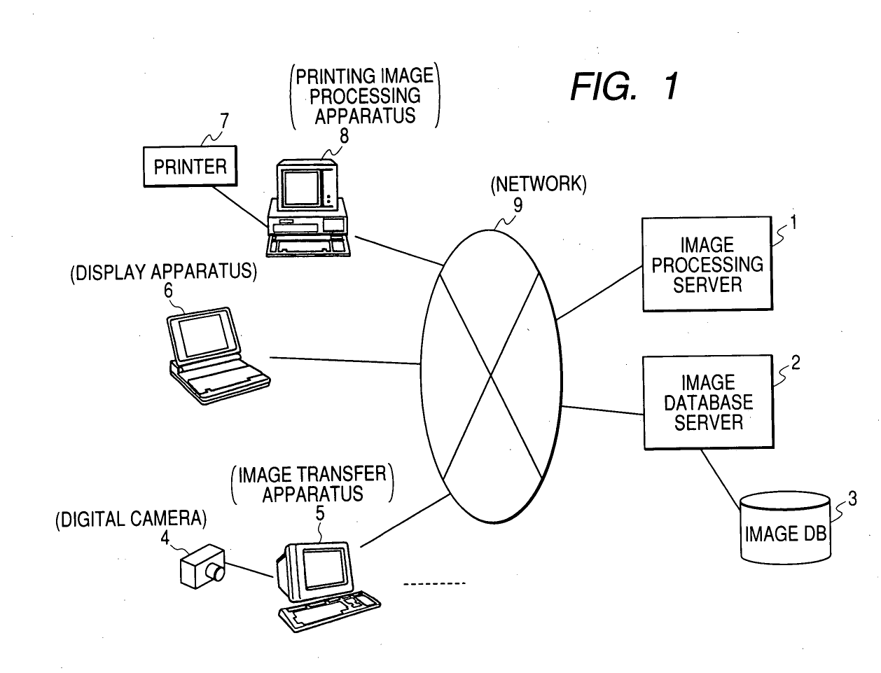

FIG. 1 shows the entire configuration of an exemplary image processing system according to the embodiment. In the image processing system, various apparatuses are connected to each other via a network 9 such as the Internet The image processing system of FIG. 1 is provided with an image processing server 1 for performing unified layout processing on images that were taken in a distributed manner, an image database server 2 for acquiring images that were taken in a distributed manner and selecting images to be subjected to the unified layout processing, and one or a plurality of image databases (image DBs) 3 that are connected to the image database server 2 and store images that were taken in a distributed manner. The image processing system is also provided with various user terminals such as image transfer apparatus 5 for reading images taken by digital cameras 4 as photographing means and transferring those to the image database server 2 via the network 9, a display apparatus 6 for displaying images that have been subjected to the unified layout processing in the image processing server 1, and an printing image processing apparatus 8 for performing various kinds of image processing that are necessary for allowing a printer 7 as an image print output means to output images that have been subjected to the unified layout processing in the image processing server 1. Each of the image transfer apparatus 5, the display apparatus 6, and the printing image processing apparatus 8 may be a computer such as a notebook-sized computer (notebook-sized PC) or a desktop PC. Each of the image processing server 1 and the image database server 2 may be implemented by one of various kinds of computers such as PCs. In the embodiment, a plurality of images that were taken in a distributed manner at different locations under different photographing conditions are unified together. Therefore, the plurality of digital cameras 4 are provided and the plurality of image transfer apparatus 5 that are connected to the respective digital cameras 4 are connected to the network 9.

For example, each of the image processing server 1 and the image database server 2 and each of the image transfer apparatus 5, the display apparatus 6, and the printing image processing apparatus 8 that are PCs or the like are equipped with a CPU (central processing unit) for controlling the entire apparatus and performing computation, a ROM in which programs for operation of the apparatus are stored, a RAM (e.g., DRAM (dynamic random access memory)) that is an internal storage device as a work memory for the CPU, and I/O circuits that are connected to input devices for accepting an input from a user that are a keyboard, a mouse, etc. and output devices such as a printer and a monitor and that manage input to and output from those peripheral devices. Each of the above apparatus is also equipped with a VRAM (video RAM) or the like as a work memory to which sample images etc. to be output on an output device for monitoring are written, as well as an HDD (hard disk drive) and an external storage device that is one of various disc storage devices such as a DVD (digital versatile disc) device and a CD (compact disc) device. The image database 3 may be such an external storage device.

Now, to facilitate understanding, the unified layout processing according to the embodiment will be compared with conventional layout processing.

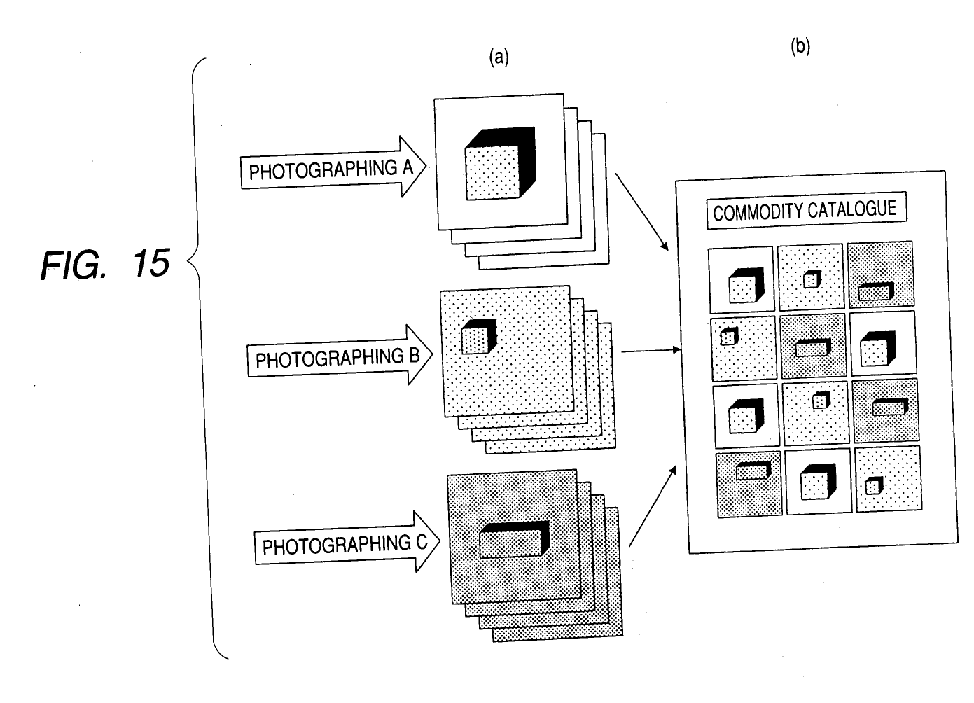

FIG. 15 shows an example in which the unified layout processing according to the embodiment (described later) has not been performed. In column (a) shown in FIG. 15, photographing A, photographing B, and photographing C produce images in different environments and the images are sent from the image transfer apparatus 5 to the image database server 2 and stored in the image DB(s) 3 as one or a plurality of memories. For example, in documents of photographing A, main objects are photographed so as to become relatively large figures and photographing is performed at sufficiently high brightness so as to produce images those brightness is relatively high. In documents of photographing B, main objects are photographed so as to become small figures and the brightness of images is not high. Further, the main objects are deviated from the centers and hence the layout is not preferable. In documents of photographing C, main objects are photographed so as to become figures having proper sizes but the illuminance is very low to produce dark images. If the images taken under such different photographing conditions are arranged without being subjected to any processing, a result becomes as shown in column (b) in FIG. 15, for example. The sizes of figures corresponding to the main objects vary to a large extent and their positions in the respective images are not fixed. Further, the image quality, that is, the brightness, the color representation, etc., varies to a large extent and hence the quality of a resulting document is very low.

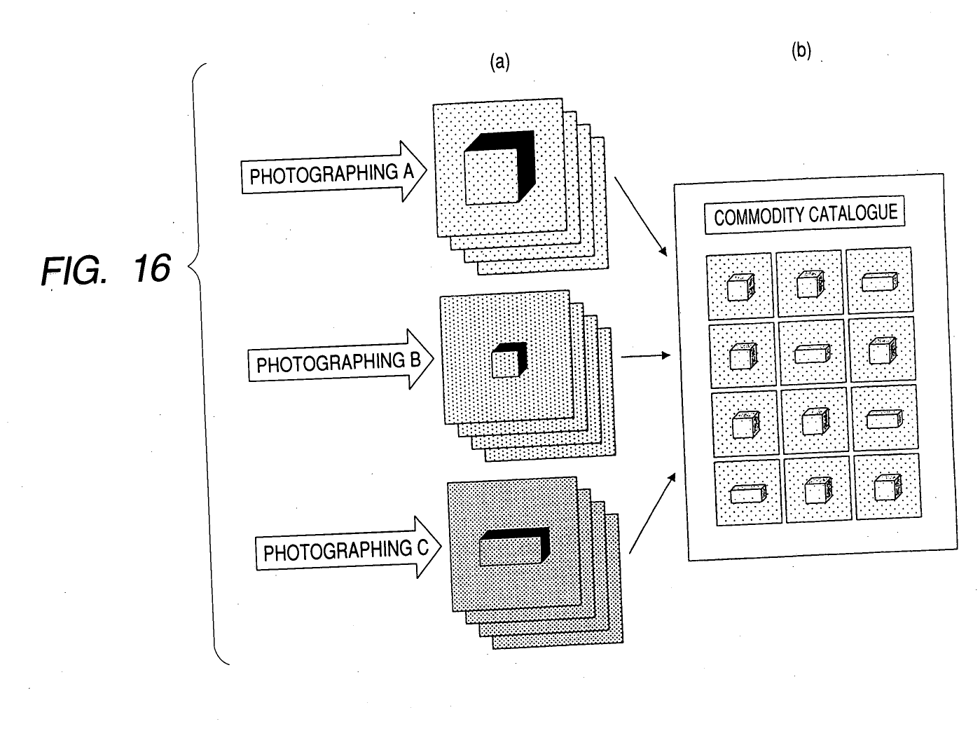

FIG. 16 shows an example in which the unified layout processing according to the embodiment has been performed. If images that are taken in different environments and hence have different levels of image quality and different object geometrical features as in the case of column (a) of FIG. 15 are subjected to the unified layout processing, a unified document as shown in column (b) in FIG. 16 can be obtained automatically by selecting an image that gives a user an impression he or she desires. To obtain such a document, a user is requested to designate, from the images of column (a) shown in FIG. 16, an image (target image, selected image) the user wants to refer to in unifying the images. Either one image or a plurality of images may be designated. Geometrical characteristic parameters of a main object and/or characteristic parameters for image processing are extracted from the designated image, and standards are set on the basis of the extracted characteristic parameters. Where a plurality of images are selected, standards are set by performing statistical processing, for example, on the characteristic parameters of the selected images. Each image is corrected according to the thus-set standards. In the embodiment, the images are corrected so that not only the brightness values of the main objects but also the backgrounds are unified among the images. More specifically, geometrical characteristic parameters such as a size and a position are extracted from the selected image first and then characteristic parameters relating to image quality such as image brightness and a color representation are extracted. Standards are set on the basis of the characteristic parameters under certain conditions, and a unified layout image is generated by correcting the images so that they satisfy the standards. As a result, an attractive layout image in which the constituent images are unified in size, position, background, and brightness, can be obtained like a commodity catalogue shown in column (b) in FIG. 16, for example.

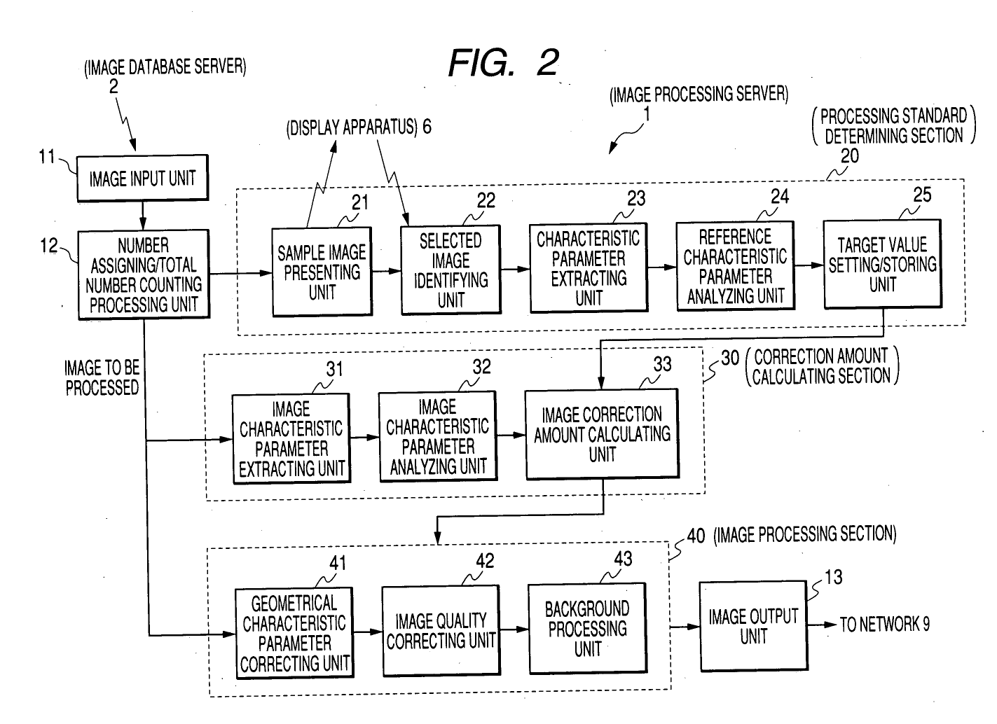

FIG. 2 shows functional block diagram for performing the unified layout processing according to the embodiment exemplified in FIG. 16. The image processing server 1 that mainly performs the unified layout processing is equipped with an image input unit 11 for acquiring image data (digital images) stored in the image database 3 from the image database server 2, a number assigning/total number counting processing unit 12 for performing preprocessing such as assigning of image numbers Gn to a plurality of images that have been input through the image input unit 11 and total number counting, and an image output unit 13 for sending image-processed images to the network 9 individually or in a laid-out state. The image processing server 1 is also equipped with a processing target determining section 20 for calculating processing targets on the basis of images that have been processed by the number assigning/total number counting processing unit 12, a correction amount calculating section 30 for analyzing characteristic parameters of an individual image that has been input through the image input unit 11 and subjected to the preprocessing such as the assigning of an image number Gn and the total number counting in the number assigning/total number counting processing unit 12 and for calculating image correction amounts according to an output of the processing target determining section 20, and an image processing section 40 for performing various kinds of image processing on the basis of the correction amounts for the individual image that have been calculated by the correction amount calculating section 30.

By the correction amount calculating section 30, it becomes possible to analyze each image state to be subjected to actual image processing and to correct for a difference from a determined processing target on an image-by-image basis. However, a configuration without the correction amount calculating section 30 may be possible. In this case, determined processing is performed uniformly according to a processing target determined by the processing target determining unit 20 irrespective of each image state. Depending on the content of processing, switching may be made between these two kinds of processing methods. For example, in the case of processing of giving the same background, a processing target is determined from a plurality of selected images by decision by majority, averaging, or the like and uniform processing is performed irrespective of each image state. On the other hand, to make brightness levels of images equal to their average, it is preferable to analyze each image state by the correction amount calculating section 30 and then correct for a difference from a processing target.

Herein, the above functions will be described in detail individually. The processing target determining section 20 is equipped with a sample image presenting unit 21 for presenting, to a user of the display apparatus 6, for example, via the network 9, a plurality of sample images that allow the user to select an image (image data) that is close to one the user imagines, and a selected image identifying unit 22 for accepting selection, by the user, of a target image (selected image) from the sample images presented by the sample image presenting unit 21. The processing target determining section 20 is also equipped with a characteristic parameter extracting unit 23 for extracting characteristic parameters of the target image, a reference characteristic parameter analyzing unit 24 for analyzing the extracted characteristic parameters, and a target value setting/storing unit 25 for calculating processing targets on the basis of the identified image, setting target values on the basis of the calculated processing targets, and storing the set values in a memory (not shown).

The correction amount calculating section 30 is equipped with an image characteristic parameter extracting unit 31 for extracting characteristic parameters such as geometrical characteristic parameters and/or image quality characteristic parameters of an image to be subjected to correction processing (i.e., subject image for correction), an image characteristic parameter analyzing unit 32 for analyzing the characteristic parameters extracted by the image characteristic parameter extracting unit 31, and an image correction amount calculating unit 33 for calculating correction amounts of the image on the basis of the characteristic parameters analyzed by the image characteristic parameter analyzing unit 32 and the target values calculated by the target value setting/storing unit 25. The image processing section 40 is equipped with a geometrical characteristic parameter correcting unit 41 for correcting a characteristic parameter such as a position, size, or inclination of a recognized main object, an image quality correcting unit 42 for correcting image quality such as brightness, color, gray balance, or gradation, and a background processing unit 43 for a background correction such as background removal or background unification.

For example, the image quality correcting unit 42 has such functions as smoothing for noise suppression, a brightness correction for moving a reference point depending on, for example, whether the subject image for correction is on the bright side or dark side in a distribution of images, a highlight/shadow correction for adjusting a distribution characteristic of a bright portion and a shadow portion in a distribution of images, and a brightness/contrast correction for correcting brightness/contrast by obtaining a distribution state from a light/shade distribution histogram. For example, the image quality correcting unit 42 also has such functions as a hue/color balance correction for correcting a color deviation of white portions with a brightest white region as a reference, a saturation correction for performing such processing as making an image with somewhat low saturation more vivid and lowing the saturation of an image that is close to gray, and a stored color correction relating to a particular stored color such as making a skin color closer to a stored one as a reference color. The image quality correcting unit 42 may also have a sharpness enhancement function that judges edge intensity from edge level of the entire image and corrects the image to a sharper one, for example.

Next, a description will be made of processing that is performed by each of the functional blocks shown in FIG. 2.

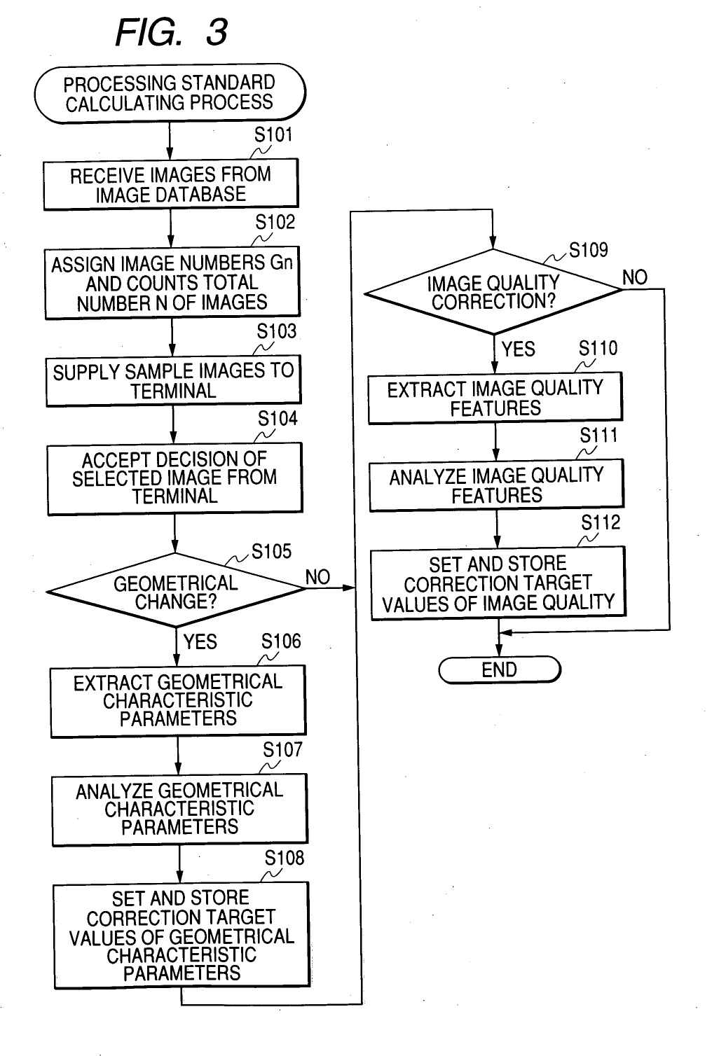

FIG. 3 is a flowchart of a process that is mainly executed by the processing target determining section 20 of the image processing server 1. First, the image input unit 11 receives images (image data, digital images) from the image database server 2 via the network 9, for example (step 101). The number assigning/total number counting processing unit 12 assigns image numbers Gn to the input images and counts the total number N of images (step 102). The images that are thus input and assigned numbers may be images that a user at one of the various user terminals such as the display apparatus 6 and the printing image processing apparatus 8 designates as images he or she wants to correct.

The sample image presenting unit 21 of the processing target determining section 20 supplies sample images to the user terminal such as the display apparatus 6 or the printing image processing apparatus 8 (step 103). The sample images are presented according to any of various display formats (described later), and the user terminal displays those using a browser, for example. It is preferable that the method for presenting the sample images be such that, for example, a plurality of images are arranged in reduced form to enable a user to make comparison and selection. The user terminal may add guide information that helps a user select target image data. Examples of the guide information are a text display, an emphasis display, and a selection button. The selected image identifying unit 22 accepts decision of a selected image from the user terminal (step 104). Either one image or a plurality of images may be decided as a selected image(s).

After the decision of a selected image, it is determined whether calculation of a processing target based on the selected image is for a geometrical change (step 105). For example, this determination is made on the basis of presence/absence of designation from a user terminal. An example of the geometrical change is a layout change, and examples of the layout change are a margin adjustment and a size adjustment such as enlargement/reduction. If no geometrical change is designated, the process goes to step 109. If processing targets for a geometrical change should be calculated, geometrical characteristic parameters are extracted from the selected image (step 106). The extracted geometrical characteristic parameters are analyzed (step 107) and correction target values of the geometrical characteristic parameters are set and stored in the memory such as a DRAM (step 108). Where a plurality of selected images were decided, each correction target value is set by, for example, averaging calculated geometrical characteristic parameters.

Then, it is determined whether an image quality correction should be made (step 109). For example, this determination is made on the basis of presence/absence of designation from a user terminal. An example of the image quality correction is correcting the brightness, vividness, contrast, sharpness, hue, or the like by referring to the selected image. If no image quality correction is necessary, the processing target calculating process is finished. If an image quality correction is necessary, features relating to image quality are extracted from the selected image that was decided at step 104 (step 110) and are analyzed (step 111). Then, image quality correction target values are set and stored in the memory such as a DRAM (step 112). The process is then finished. Where a plurality of selected images were decided, each correction target value is set by, for example, averaging extracted image quality features.

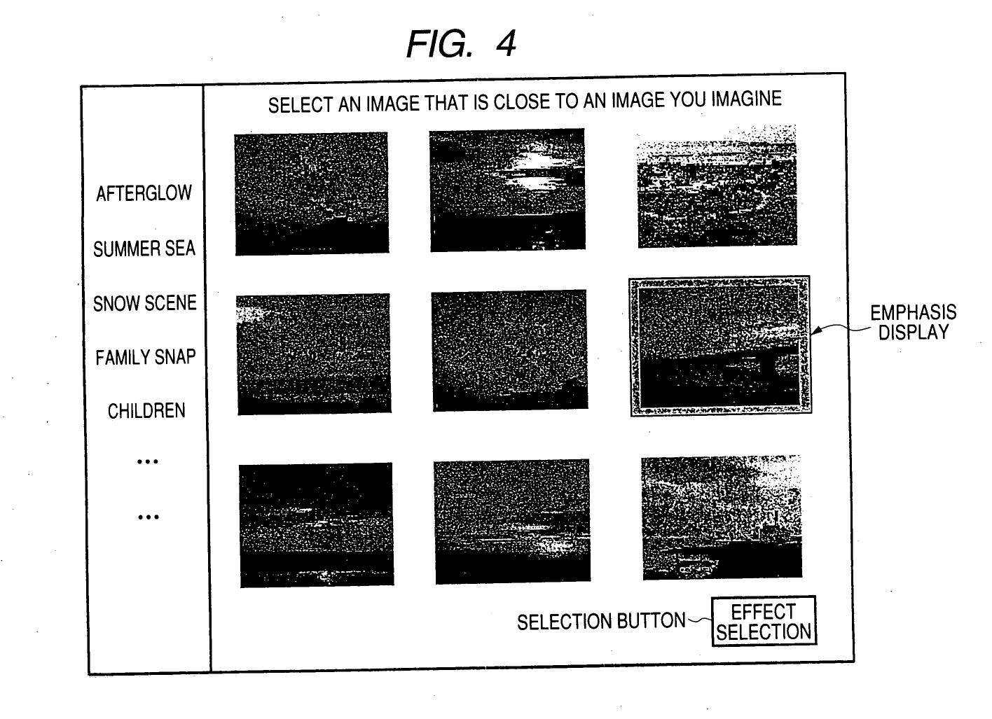

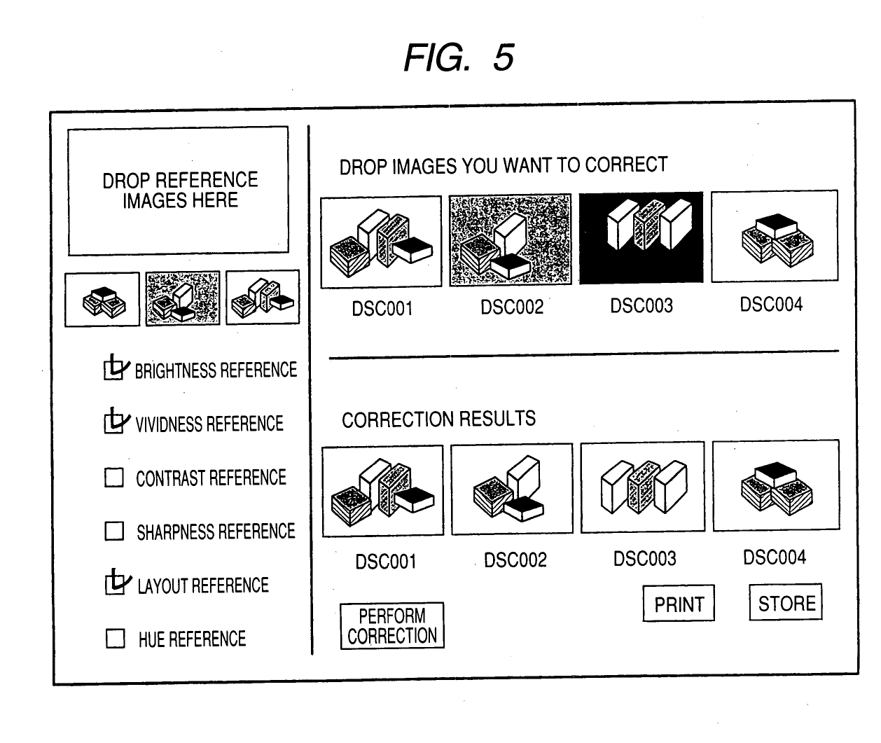

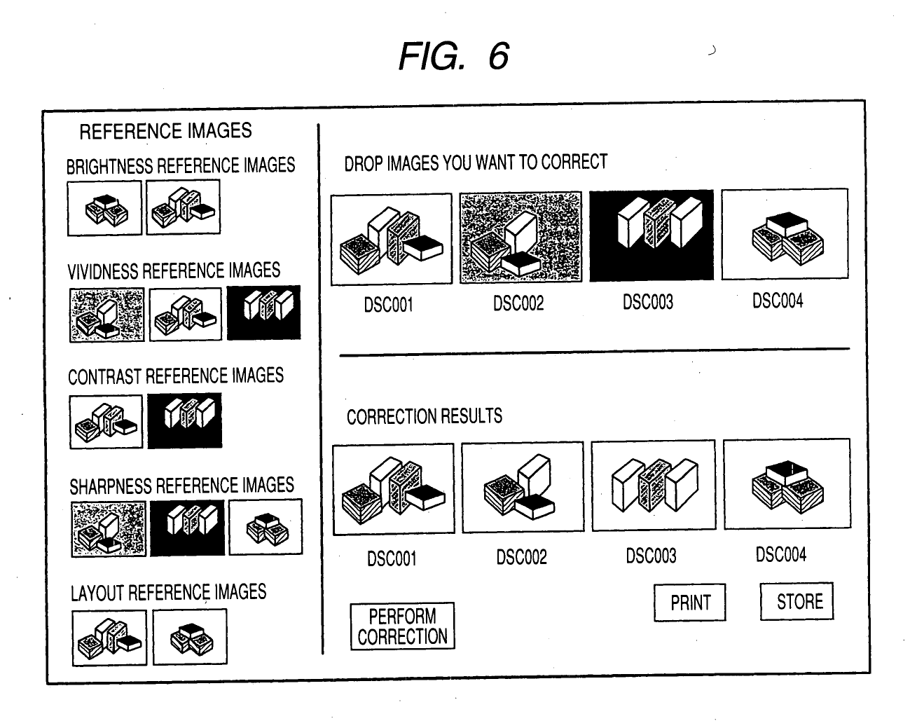

Next, exemplary sample images that are presented at step 103 and manners of decision of a selected image at step 104 will be described with reference to FIGS. 4-6. In FIGS. 5 and 6, the term “reference image” has the same meaning as “selected image.”

FIG. 4 shows a first exemplary user interface that presents a plurality of sample images to a user and causes the user to select one of those. Image information shown in FIG. 4 is displayed on the display device of a computer (user terminals) such as the display apparatus 6 or the printing image processing apparatus 8 shown in FIG. 1. In this example, nine images are displayed as sample images for selection. In addition to these nine actual images, a message such as “Select an image that is close to an image you imagine” and guide information such as explanations of the respective images “afterglow,” “summer sea,” “snow scene,” and “family snap” are displayed. To increase choices of the user, it is preferable to present, as sample images, images having much different features. If the user selects an image that is close to an image he or she imagines by using an input device such as a mouse relying on the guide information, an emphasis display such as a thick frame enclosing the selected image is made as shown in FIG. 4. The selection takes effect upon depression of a selection button. The information of the selected image is sent to the selected image identifying unit 22 of the image processing server 1 via the network 9.

Whereas in the example of FIG. 4 the sample images are presented for selection, FIG. 5 shows a second exemplary user interface in which a user makes instructions to register sample images. It a user drops one or more images, for example, DSC004, DSC002, and DSC001, into a region with a message “Drop reference images here” and selects a correction item “brightness reference,” for example, the selection means that an average of brightness values of the three images should be referred to. Likewise, selection may be made so that average vividness or an average layout should be referred to. If a “perform correction” button is depressed after the selection of reference images and reference items, results are sent to the selected image identifying unit 22 of the image processing server 1 via the network 9. Although in this example images to be corrected (i.e., subject image for corrections) and reference images are designated from the same group of images, reference images need not be part of images to be corrected (i.e., subject image for corrections) and other images may be selected as sample images.

Then, the processing target determining section 20 shown in FIG. 2 extracts characteristic parameters corresponding to the respective reference items and sets target values on the basis of the selected images thus determined. The correction amount calculating section 30 extracts characteristic parameters of each of the images DSC001 to DCS004 and calculates image correction amounts on the basis of the target values that have been set by the processing target determining section 20. In the image processing section 40, image processing is performed on each of the images DSC001 to DCS004 by the image correcting unit 42 (for brightness and vividness) and the geometrical characteristic parameter correcting unit 41 (for layout). Results are sent from the image output unit 13 to the display apparatus 6, the printing image processing apparatus 8, or the like via the network 9 and are output there. For example, output correction results are as shown in a bottom-right part of FIG. 5. For example, the images DSC002 and DSC003 have been corrected so that they are made brighter as a whole and the positions of the main objects are changed to the centers. The corrected images are stored in a storing means such as an HDD upon depression of a “store” key. Upon depression of a “print” key, the corrected images are printed by the printer 7, for example.

FIG. 6 shows a third exemplary user interface that presents a plurality of sample images to a user and causes the user to select one or some of those. As in the example of FIG. 5, four images DSC0001 to DSC0004 with an instruction “Drop images you want to correct” are displayed on the display device of the display apparatus 6, for example, by the sample image presenting unit 21. In the example of FIG. 6, t different sets of images are used as sets of sample images for respective characteristic parameters. A plurality of sample images may be selected as each set of sample images. For example, if a user drops images DSC004 and DSC001, for example, into a region with a message “Drop reference images here” as shown in FIG. 5 (not shown in FIG. 6 because of a limited space) and selects a correction item “brightness reference,” for example, the images DSC004 and DSC001 are selected as brightness reference images. Likewise, vividness reference images, contrast reference images, sharpness reference images, and layout reference images are selected. If a “perform correction” button is depressed after the selection of sets of reference images for respective characteristic parameters, results are sent to the selected image identifying unit 22 of the image processing server 1 via the network 9.

Then, the processing target determining section 20 shown in FIG. 2 extracts characteristic parameters corresponding to each reference item from the selected images that have been decided for each characteristic parameter and sets a target value. The reference characteristic parameter analyzing unit 24 calculates an average, for example, of the characteristic parameters, and the target value setting/storing unit 25 sets a target value for each characteristic parameter. The correction amount calculating section 30 calculates an image correction amount for each of the images DSC001 to DCS004 by using the set target value. The image processing section 40 performs image processing on each of the images DSC001 to DCS004. Results are sent from the image output unit 13 to the display apparatus 6, the printing image processing apparatus 8, or the like via the network 9 and are output there. For example, output correction results are as shown in a bottom-right part of FIG. 6. The corrected images are stored in a storing means such as an HDD upon depression of a “store” key. Upon depression of a “print” key, the corrected images are printed by the printer 7, for example.

Next, the extraction of characteristic parameters from a selected image (target image) and the setting of target values (steps 106-108 and 110-112 in FIG. 3) will be described in more detail for each of geometrical characteristic parameters and image quality characteristic parameters.

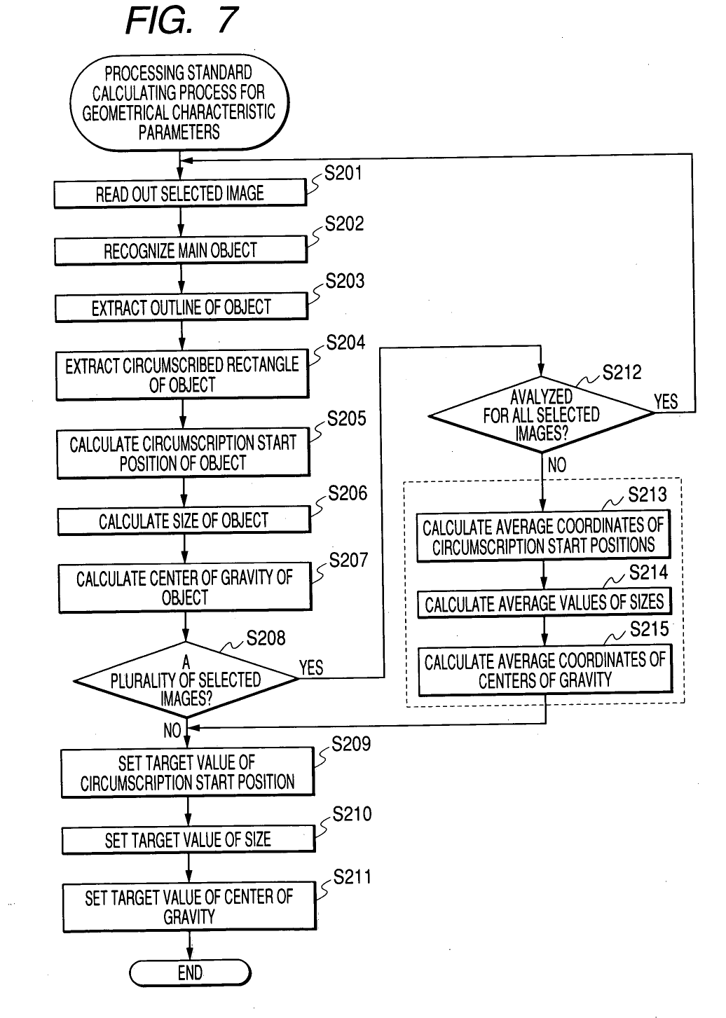

FIG. 7 is a flowchart of a processing target calculating process for geometrical characteristic parameters, which corresponds to steps 106-108 in FIG. 3.

First, in the characteristic parameter extracting unit 23 of the image processing server 1, a selected image (selected image data) is read out (step 201) and a main object is recognized (step 202). After an outline of the recognized main object (abbreviated as “object”) is extracted (step 203), a circumscribed rectangle of the object is extracted (step 204). After geometrical characteristic parameters are extracted in this manner, they are analyzed. That is, a circumscription start position of the object is calculated (step 205) and a size of the object is calculated (step 206). Then, the center of gravity of the object is calculated (step 207).

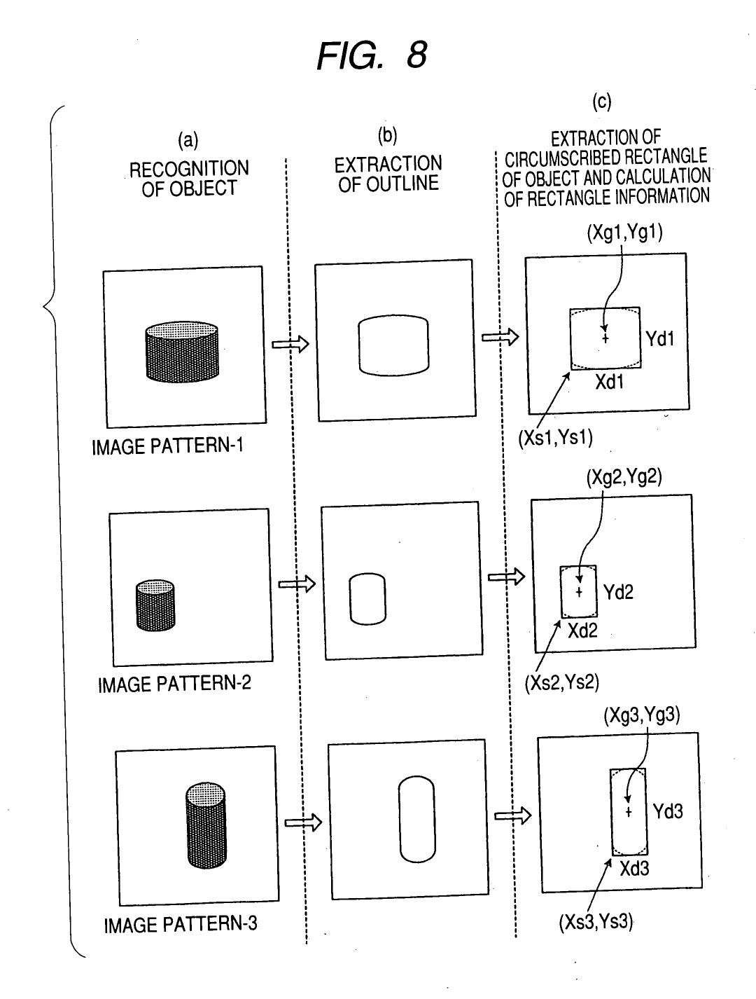

FIG. 8 illustrates details of the above-described is steps 201-207 (steps 106 and 107 in FIG. 3). A processing target calculating process will be described for an example in which three selected images, that is, image pattern-1 to image pattern-3, have been decided. In FIG. 8, column (a) shows recognition of objects, column (b) shows extraction of outlines, and column (c) illustrates extraction of circumscribed rectangles of the objects and calculation of rectangle information. First, as shown in column (a) of FIG. 8, the main objects are recognized by separating those from the backgrounds. Then, outlines of image pattern-1 to image pattern-3 are extracted, whereby solid-white figures, for example, are obtained as shown in column (b) of FIG. 8. Circumscribed rectangles of the objects are extracted from the extracted outlines as shown in column (c) of FIG. 8. For the respective images, circumscription start positions (e.g., (Xs1, Ys1), (Xs2, Ys2), and (Xs3, Ys3)) of the objects, sizes (e.g., (Xd1, Yd1), (Xd2, Yd2), and (Xd3, Yd3)) of the objects, and centers of gravity (e.g., (Xg1, Yg1), (Xg2, Yg2), and (Xg3, Yg3)) of the objects are calculated from the extracted circumscribed rectangles.

The description of the flowchart of FIG. 7 will be continued below. After the execution of steps 201-207, it is determined whether a plurality of selected images exist (step 208). It only a single selected image exists, the process goes to step 209. If a plurality of selected images exist as in the example of FIG. 8, the process goes to step 212. If only a single selected image exists, the process goes to step 108 in FIG. 3 (i.e., setting and storage of target values). That is, a target value of the circumscription start position is set (step 209), a target value of the size is set (step 210), and a target value of the center of gravity is set (step 211). The thus-set target values are stored in the prescribed memory and the processing target calculating process for geometrical characteristic parameters is finished.

If it is determined at step 208 that a plurality of selected images exist, it is determined whether the extraction and analysis of characteristic parameters, that is, steps 201-207, have been performed for all the selected images (step 212). If not all centers of gravity have been calculated, the process returns to step 201 to execute steps 201-207 again. It all centers of gravity have been calculated, steps 213-215 (i.e., calculation of averages) are executed. More specifically, in the example of FIGS. 8(a)-8(c), at step 213, average coordinates (XsM, YsM) of the circumscription start positions are calculated as XsM=average(Xs1, Xs2, Xs3) and YsM=average(Ys1, Ys2, Ys3). At step 214, average values of the sizes are calculated as XdM=average(Xd1, Xd2, Xd3) and YdM=average(Yd1, Yd2, Yd3). At step 215, average coordinates of the centers of gravity are calculated as XgM=average(Xg1, Xg2, Xg3) and YgM=average(Yg1, Yg2, Yg3). After the processing targets in the case where a plurality of selected images were decided have been calculated in the above manner, the above-described steps 209-211 are executed and the processing target calculating process for geometrical characteristic parameters is finished.

Alternatively, target values of geometrical characteristic parameters may be determined according to an instruction of a user. For example, target values may be determined by displaying, on the display device, options such as:
to locate the centers of gravity of objects at the centers;
to employ the values of the largest object;
to employ the values of the smallest object; and
to average the sizes and the positions,
   and let the user designate one of the above items. The method for setting target values shown in FIG. 7 is such that when a plurality of selected images exist, averages are calculated automatically as target values. Where a user specifies a target value setting method, the target value setting/storing unit 25 can change the target value setting method according to an instruction of the user and store resulting target values in the memory. As a further alternative, target values may be set in an actual correcting process.

Next, the calculation of processing targets of image quality characteristic parameters, which corresponds to steps 110-112 in FIG. 3, will be described.

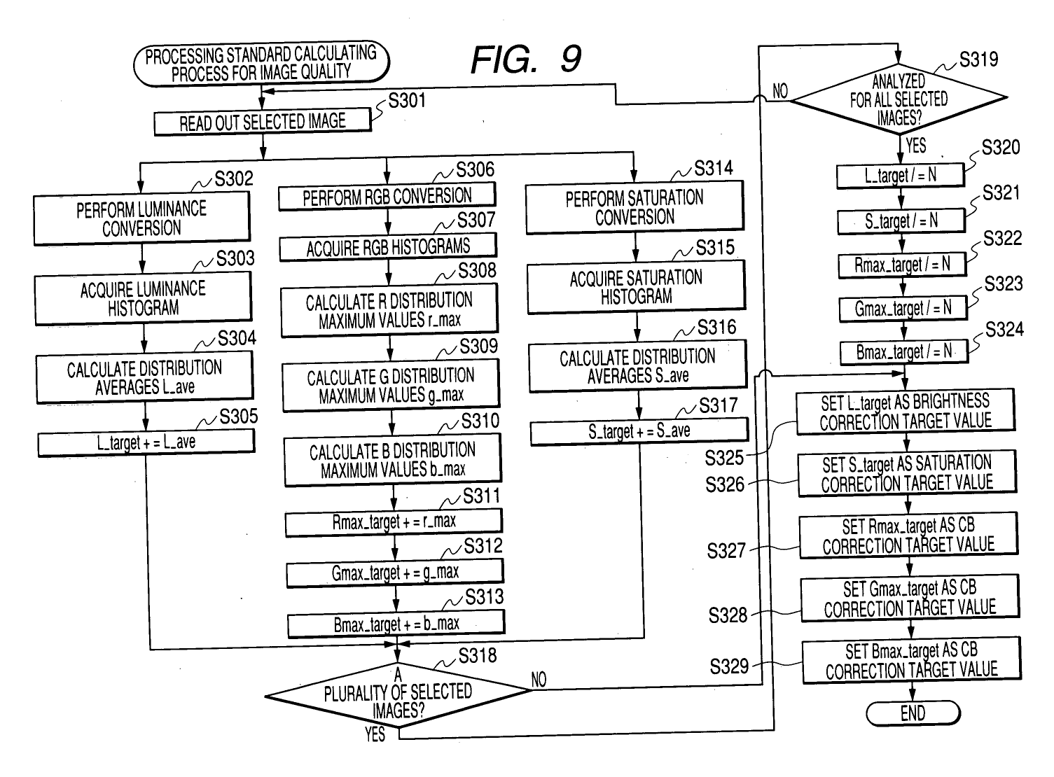

FIG. 9 is a flowchart of a processing target calculating process of image quality characteristic parameters. First, the characteristic parameter extracting unit 23 of the image processing server 1 reads out a selected image (step 301). Then, target value setting is performed for each of the luminance, R (red), G (green), B (blue), and saturation. First, a luminance conversion is performed, that is, conversion is made into L*a*b*, for example (step 302) and a luminance histogram is acquired (step 303). Then, distribution averages L_ave are calculated (step 304) and L_target is obtained by adding up the calculated averages L_ave (step 305). This luminance conversion is used for a highlight/shadow correction or a brightness/contrast correction. For example, in the brightness/contrast correction, a light/shade distribution (e.g., histogram) is acquired from a reference image and a value that provides approximately the same distribution graphs is made a target value (for example, about five ranges are set).

On the other hand, an RGB conversion is performed for a hue/color balance correction, for example (step 306). First, RGB histograms are acquired for a main object that is separated from the background (step 307). R distribution maximum values r_max are calculated (step 308), G distribution maximum values g_max are calculated (step 309), and B distribution maximum values b_max are calculated (step 310). A value Rmax_target is obtained by adding up the calculated maximum values r_max (step 311), Gmax_target is obtained by adding up the calculated maximum values g_max (step 312), and Bmax_target is obtained by adding up the calculated maximum values b_max (step 313). In performing a hue/color balance correction, RGB histograms are separately acquired in this manner. For example, a point corresponding to the brightest RGB histogram ranges is determined white. And it a yellowish or greenish shift exists, it is determined that a deviation from white has occurred there and a white balance adjustment is made.

Further, a saturation conversion is performed for a saturation correction (step 314). First, a saturation histogram is acquired for a main object that has been separated from the background (step 315), and distribution averages S_ave are calculated (step 316). A value S_target is calculated by adding up the calculated distribution averages S_ave (step 317). The saturation can be represented by using the two planes (a*b*) of L*a*b*. Cray corresponds to a*b* being 00. Correction rules are as follows. The saturation scale is contracted in a range that is close to gray, that is, faintly colored portion is corrected so that the saturation is lowered, that is, made closer to gray. A medium or high saturation portion is corrected so that the vividness is enhanced. At steps 314-317, target values for the saturation correction are determined on the basis of distribution averages of the selected image.

After the execution of steps 301-317, it is determined whether a plurality of selected images exist (step 318). If only a single selected image exists, the process goes to target value setting steps (i.e., steps 325-329) to be executed by the target value setting/storing unit 25. The calculated value L_target is set as a brightness correction target value (step 325), S_target is set as a saturation correction target value (step 326), Rmax_target is set as a color balance (CB) correction target value (step 327), Gmax_target is set as another color balance (CB) correction target value (step 328), and Bmax_target is set as still another color balance (CB) correction target value (step 329). These correction target values are stored in the prescribed memory (not shown) and the process for calculating processing targets for image quality is finished.

If it is determined at step 318 that a plurality of selected images exist, it is determined whether the analysis has been performed for all the selected images (step 319). If the analysis has not been performed for all the selected images, the process returns to step 301 to execute steps 301-317 again. If the analysis has been performed for all the selected images, the reference characteristic parameter analyzing unit 24 calculates an average by dividing the sum of the calculation results of the plurality of (N) selected images by N. That is, an average is calculated by dividing the sum of the values L_target of the respective images by N (step 320), and an average is calculated by dividing the sum of the values S_target of the respective images by N (step 321). Likewise, an average of the values Rmax_target is calculated (step 322), an average of the values Gmax_target is calculated (step 323), and an average of the values Smax_target is calculated (step 324). The target setting/storing unit 25 sets the average L_target as a brightness correction target value (step 325), sets the average S_target as a saturation correction target value (step 326), sets the average Rmax_target as a color balance (CB) correction target value (step 327), sets the average Gmax_target as another color balance (CB) correction target value (step 328), and sets the average Bmax_target as still another color balance (CB) correction target value (step 329). The target setting/storing unit 25 stores these correction target values in the prescribed memory (not shown) and the process for calculating processing targets for image quality is finished.

As described above, the processing target determining section 20 sets target values on the basis of a selected image(s) and stores those in the memory according to the process of FIG. 3.

Next, a correction process that is executed by the correction amount calculating section 30 and the image processing section 40 will be described for each of geometrical characteristic parameters and image quality characteristic parameters.

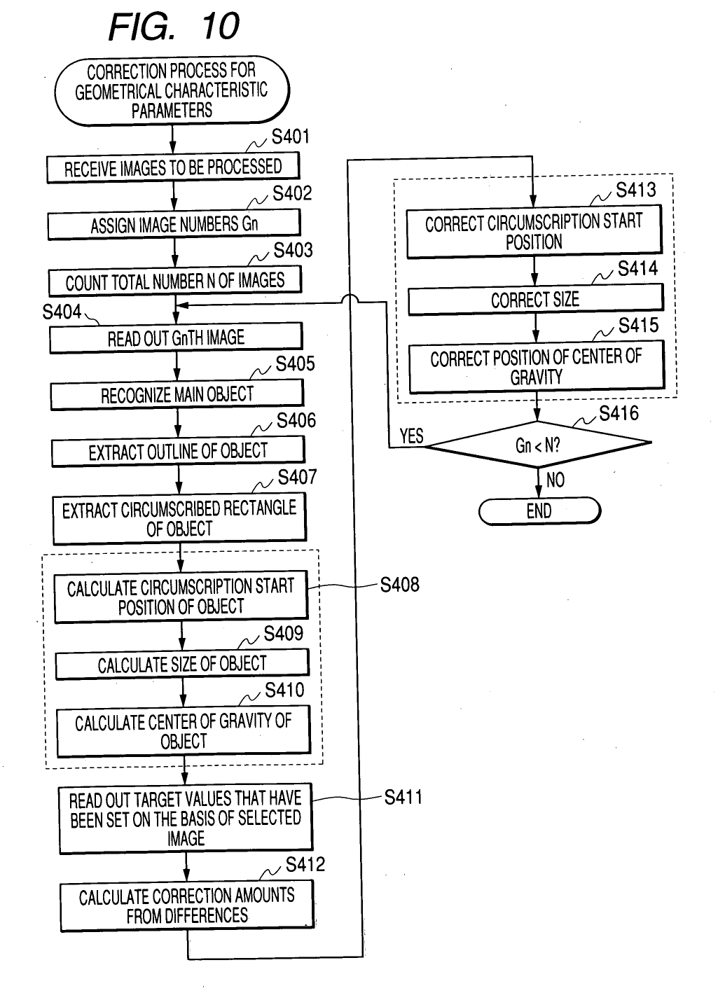

First, a correction process for geometrical characteristic parameters will be described FIG. 10 is a flowchart of a correction process for geometrical characteristic parameters.

In the correction process for geometrical characteristic parameters, actual correction processing is performed on the basis of target values of various processing targets that have been acquired by the process of FIG. 7. In the correction process for geometrical characteristic parameters, in the image processing server 1 shown in FIG. 2, first, the image input unit 11 receives images (image data, digital images) to be processed (step 401) and the number assigning/total number counting processing unit 12 assigns image numbers Gn to the respective input images (step 402) and counts the total number N of images to be processed (step 403). Images to be corrected may be taken out (designated) arbitrarily by a user terminal such as the display apparatus 6 shown in FIG. 1. In this case, the total number N of images is the number of all images designated by the user terminal. Then, the image characteristic parameter extracting unit 31 of the correction amount calculating section 30 reads out a Gnth image (a first image at the beginning) from the N images (step 404). A main object to be processed is recognized (step 405), an outline of the recognized main object (abbreviated as “object”) is extracted (step 406), and a circumscribed rectangle of the object is extracted (step 407). Then, the image characteristic parameter analyzing unit 32 analyzes characteristic parameters of the image to be processed. Specifically, a circumscription start position of the object is calculated (step 408), a size of the object is calculated (step 409), and the center of gravity of the object is calculated (step 410). Depending on the image correction process, not all of the above steps are executed.

Then, the image correction amount calculating unit 33 reads out target values that have been set on the basis of a selected image(s) and stored by the target value setting/storing unit 25 (step 411), and calculates correction amounts from the differences between the characteristic parameters analyzed by the image characteristic parameter analyzing unit 32 and the read-out target values (step 412). The calculated correction amounts are output to the image processing section 40. The geometrical characteristic parameter correcting unit 41 of the image processing section 40 corrects a necessary one(s) of the circumscription start position (step 413), the size (step 414), and the position of the center of gravity (step 415). Then, it is determined whether the correction (s) has been made for all the N images, in other words, whether Gn<N (step 416). If Gn<N, the process returns to step 404 to execute steps 404-415 again (i.e., correction processing is performed on the next image). If Gn≧N, the correction process for geometrical characteristic parameters is finished.

How the above process is applied to the exemplary patterns of FIG. 8 will be described below. If image pattern-2 is corrected by using average coordinates (XsM, YsM) of the circumscription start positions and average values XdM and YdM of the sizes of selected images, exemplary results are as follows:
image shift: move (XsM−Xs2, YsM−Ys2) pixels
image enlargement: scale a factor YdM/Yd2 (a vertical factor is employed).

These corrections provide an easy-to-see layout image because the geometrical characteristic parameters are unified.

Next, a correction process for image quality characteristic parameters will be described.

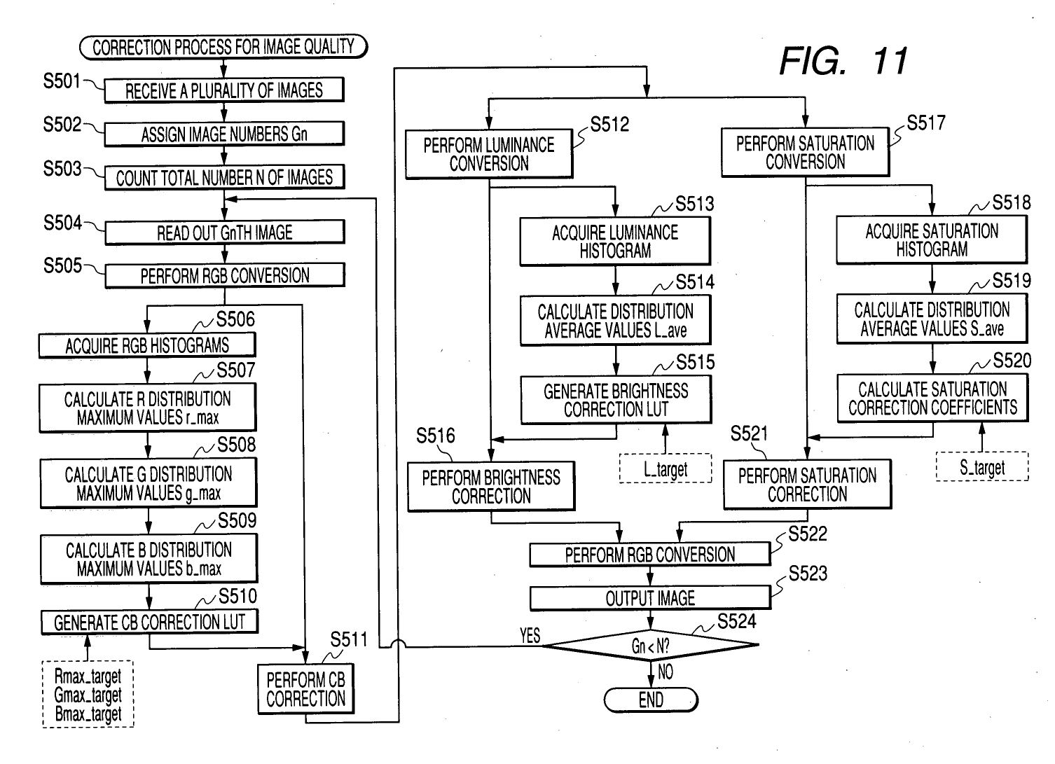

FIG. 11 is a flowchart of a correction process for image quality characteristic parameters (image quality). In the image processing server 1, first, the image input unit 11 receives a plurality of images to be processed (step 501) and the number assigning/total number counting processing unit 12 assigns, in order, image numbers Gn to the images to be processed (step 502) and counts the total number N of images to be processed (step 503). Then, the image characteristic parameter extracting unit 31 reads out a Gnth image (for example, the N images are read out in ascending order of the image numbers Gn starting from the Glth image) (step 504) and performs an RGB conversion on a main object that has been separated from the background (step 505). Subsequently, an RGS histogram is acquired (step 506), R distribution maximum values r_max are calculated (step 507), G distribution maximum values g_max are calculated (step 508), and B distribution maximum values b_max are calculated (step 509). A color balance (CB) correction LUT (look-up table) is generated by using target values Rmax_target, Gmax_target, and Bmax_target that have been set by the target value setting/storing unit 25 on the basis of a selected image(s) according to the flowchart of FIG. 9 (step 510). A color balance correction is performed on the RGB-converted image (step 511).

Then, after conversion into L*a*b*, for example, a luminance conversion (steps 512-516) and a saturation conversion (steps 517-521) are performed on the main object of the image to be processed. In the luminance conversion (steps 512-516), a luminance histogram is acquired by using L*, for example (step 513). Then, distribution average values L_ave are calculated (step 514). A brightness correction LUT is generated by using a target value L_target that has been set by the target value setting/storing unit 25 on the basis of the selected image(s) according to the process of FIG. 9 (step 515). Then, the image quality correcting unit 42 performs a brightness correction using the brightness correction LUT (step 516). The saturation conversion of steps 517-521 is performed in the following manner. A saturation histogram is acquired by using a*b*, for example (step 518) and distribution average values S_ave are calculated (step 519). Then, saturation correction coefficients are calculated by using a target value S_target that has been set by the target value setting/storing unit 25 on the basis of the selected image(s) (step 520). A saturation correction is performed by the image quality correcting unit 42 by using the thus-set saturation correction coefficients (step 521). After the brightness and saturation corrections have been performed in the above manner, an RGB conversion is performed for conformance with an image output format (step 522) and an image is output (step 523). Then, it is determined whether the number of processed images is equal to the total number N of images, in other words, whether Gn<N (step 524). If Gn<N, the process returns to step 504 to execute steps 504-523 again. If the number of processed images is equal to the total number N of images, the correction process is finished.

Since the image quality is corrected in the above-described manner, the brightness, color, and/or vividness of an object can be made equal to that or those of a selected image(s).

If an instruction to make a background color the same as of a selected image(s) is made, the following background correcting process is executed.

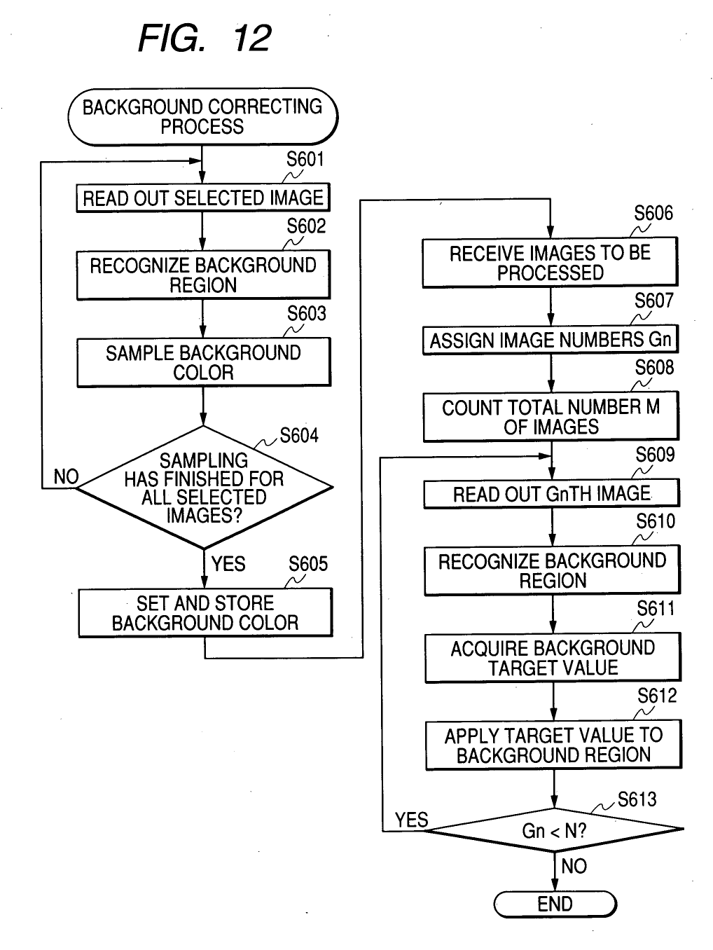

FIG. 12 is a flowchart of a process of calculation of a processing target from a background of a selected image(s) and a correction on a plurality of images. In the processing target determining section 20 of the image processing server 1, first, the selected image identifying unit 22 reads out a selected image (step 601). Then, the characteristic parameter extracting unit 23 recognizes a background region (step 602) and samples a background color (step 603). The sampled background color is basically defined by the luminance, brightness, and saturation. Then, it is determined whether the sampling has finished for all of selected images (step 604). If only a single selected image exists or the sampling of a background color has finished for all of selected images, the target value setting/storing unit 25 sets and stores the background color (step 605), whereby calculation of a processing target for a background is finished. If a plurality of selected images exist and the sampling of a background color has not finished for all the selected images, the process returns to step 601 to execute steps 601-603 again. Where criteria are set in advance, a target value that satisfies the criteria is stored. Where criteria are determined at the time of actual processing, background image information of all the selected images may be stored. Where background colors of selected imaged are averaged, the reference characteristic parameter analyzing unit 24 performs averaging or the like.

Alternatively, target values of a background color may be determined according to an instruction of a user. For example, where a plurality of images have been selected as target images, target values may be determined by displaying the options such as:
to employ a brightest background color;
to employ a darkest background color;
to employ a most vivid background color; and
to average background colors,
   and let the user designate one of those items.

Then, a background correction is performed on a plurality of images to be processed. In the image processing server 1, the image input unit 11 receives images to be processed (step 606). The number assigning/total number counting processing unit 12 assigns image numbers Gn to the respective input images (step 607) and counts the total number N of images (step 608). Then, the background processing unit 43 reads out a Gn-th image (for example, the N images are read out in ascending order of the image numbers Gn starting from the Glth image) (step 609) and recognizes a background region (step 610). The background processing unit 43 acquires the determined background target values from the image correction amount calculating unit 33 (step 611) and applies the target values to the background region of the image to be processed (step 612). Then, it is determined whether the number of processed images is equal to the total number N of images, in other words, whether Gn<N (step 613). If Gn<N, the process returns to step 609 to execute steps 609-612 again. If the number of processed images is equal to or larger than the total number N of images, the correction process is finished. In the above-described manner, background correction processing can be performed by using a selected target image(s) (sample image(s)).

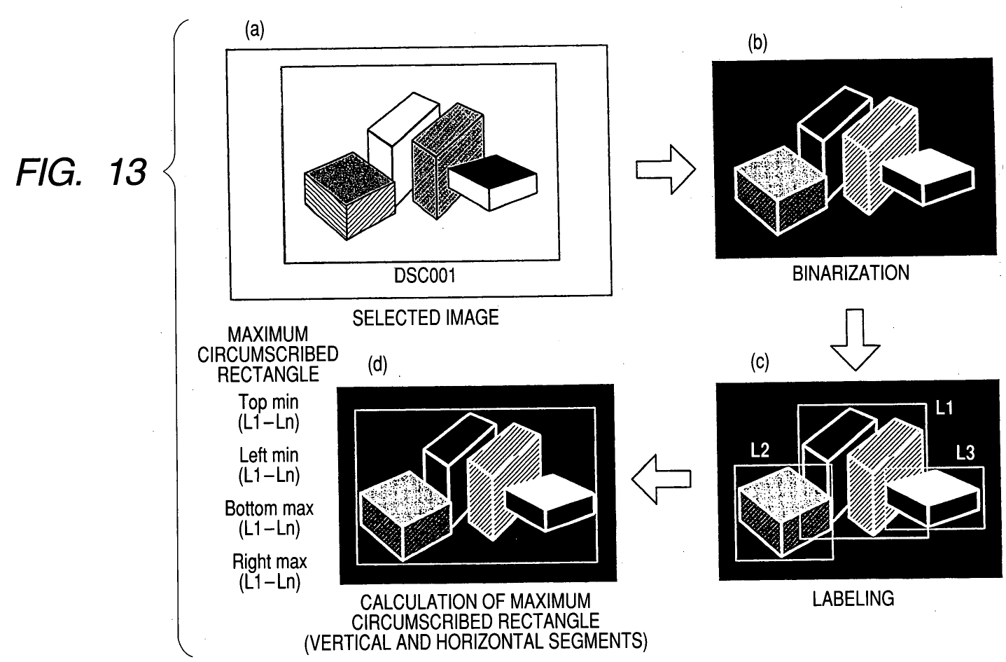

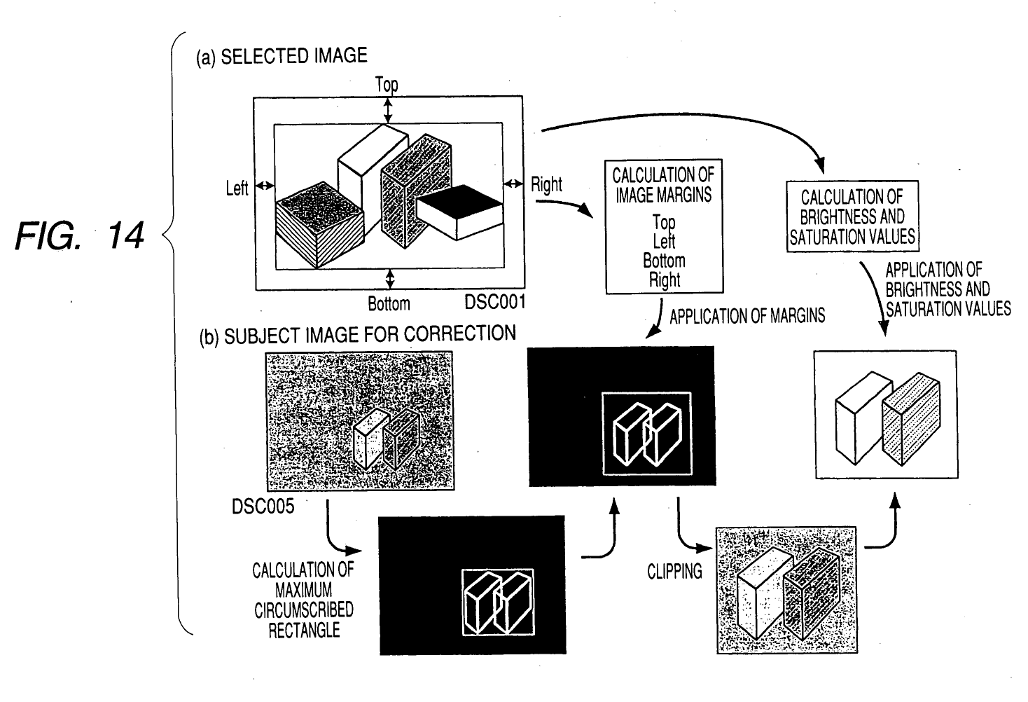

Finally, an exemplary series of processes for setting target values of geometrical characteristic parameters and image quality characteristic parameters on the basis of a selected image (target image) and applying the target values to a subject image for correction will be described with reference to FIGS. 13 and 14.

FIG. 13 illustrates a step of extracting characteristic parameters of a selected image. Section (a) of FIG. 13 shows a selected image that is displayed on the display device of the display apparatus 6 (user terminal), for example, and has been designated as a target image through the user terminal. To extract geometrical characteristic parameters, first, the selected image is binarized as shown in section (b) of FIG. 13. As shown in section (c) of FIG. 13, labeling is performed on the binarized image. In this example, three image elements L1-L3 are labeled. Then, a maximum circumscribed rectangle is calculated as shown in section (d) of FIG. 13. For example, where the origin of the coordinate system is located at the left-top corner, vertical and horizontal edges of a maximum circumscribed rectangle are calculated by: a topmost segment having smallest coordinate value; a leftmost segment having smallest coordinate value; a bottommost segment having largest coordinate value: and a rightmost segment having largest coordinate value.

FIG. 14 illustrates processing that is performed on a subject image for correction using the characteristic parameters of the selected image that have been calculated as shown in FIG. 13. In this example, four image margins, that is, top, bottom, left, and right image margins, are calculated as part of target values of the geometrical characteristic parameters of the selected image shown in section (a) of FIG. 14. A brightness value and a saturation value are calculated as part of target values of image quality characteristic parameters of the selected image shown in section (b) of FIG. 14. On the other hand, a subject image for correction shown in section (b) of FIG. 14 is binarized first and then a maximum circumscribed rectangle is calculated. The image margins that have been calculated for the selected image are applied to the thus-calculated maximum circumscribed rectangle, whereby a clipping range is determined. Then, the part of the image in the thus-determined range is clipped out and subjected to brightness and saturation corrections on the basis of the brightness and saturation values that have been calculated from the selected image. In this manner, image processing can be performed by using target values that are determined on the basis of a selected image.

As described above in detail, in the embodiment, target processing targets are determined on the basis of a selected image(s) (selected image data) selected through a user terminal and are applied to each of a plurality of images (image data). That is, sample image processing is enabled in a state that a plurality of sample images are presented to a user. In the sample image processing, correction parameters are calculated with a user-selected image(s) as a reference(s) and then processed. In the image processing apparatus, since processing is performed on the basis of a selected image(s) rather than individual image states, correction processing can be performed for an unexpected, unknown purpose. It would be possible to allow a user to set a processing target arbitrarily. However, sufficient experience is necessary for presetting saturation or brightness in the form a numerical value and it is difficult to associate an impression with a numerical value. In contrast, according to the embodiment, a user terminal recognizes an image that makes an impression on a user that he or she desires, whereby a correction amount based on the user's impression can be determined automatically and a correction can be performed simply and correctly. If processing targets are determined from a plurality of selected images, correction results can be obtained on the basis of more correct processing targets.

It is expected that the embodiment is used in various forms such as an application form, a printer driver form, and a form of cooperation with a digital camera. An exemplary application form is such that the embodiment is used as a function of making an album using images taken by a digital still camera (DSC) or a function of automatically adjusting images acquired by a user as a plug-in or the like of management software. An exemplary printer driver form is such that the embodiment is used as a function that can be selected as an optional function in driver setting or a function that is incorporated in mode setting itself. An exemplary form of cooperation with a digital camera is such that the embodiment is used as a function that enables issuance of an adjustment instruction at a printing stage (tag information is buried in a file format).

A computer program to which the embodiment is applied is supplied to the computers (user terminals) such as the image processing server 1, the image transfer apparatus 5, the display apparatus 6, and the printing image processing apparatus 8 not only in such a manner that it is installed in the computers but also in a form that it is stored in a storage medium so as to be readable by the computers and to be executed by the computers. Exemplary storage media are various DVDs, CD-ROM media, and card-type storage media. The program is read by a DVD or CD-ROM reading device, a card reading device, or the like that is provided in each of the above computers. The program is stored in any of various memories of each of the above computers such as an HDD and a flash ROM and executed by a CPU. Alternatively, the program may be supplied from a program transmission apparatus via a network.

For example, the invention can be applied to a computer that is connected to an image forming apparatus such as a printer, a server that presents information via the Internet or the like, and a digital camera, as well as a program that is executed in those various kinds of computers.

In the image processing apparatus according to one aspect of the invention, characteristic parameter recognizing means recognizes a characteristic parameter of selected image data from the selected image data that is selected by a user, and image processing means performs image processing on a plurality of image data individually using, as one of target values, the characteristic parameter of the selected image data that is recognized by the characteristic parameter recognizing means. The term “image data” is used here as having approximately the same meaning as “image.” This also applies to this entire specification.

In the image processing apparatus, the selected image data is one or some of the plurality of image data that are stored in one or a plurality of memories. The characteristic parameter recognizing means supplies sample images to a user terminal and the selected image data is selected by making an input on the sample images through the user terminal. The characteristic parameter recognizing means recognizes a geometrical characteristic parameter of one or a plurality of selected image data, and/or recognizes, as the characteristic parameter, an image quality characteristic parameter including at least one of brightness, contrast, saturation, hue, and a resolution of one or a plurality of selected image data.

The “user terminal” may be a computer that is connected via a network or a computer that functions as the image processing apparatus by itself. This also applies to this entire specification.

In an image processing apparatus according to another aspect of the invention, display means displays a plurality of image data in listed form and recognizing means recognizes, as selected image data, one or some of the plurality of image data displayed. Characteristic parameter recognizing means recognizes a characteristic parameter of the selected image data from the selected image data that is recognized by the recognizing means, and setting means sets the recognized characteristic parameter as one of target values of image correction processing on image data to be subjected to image processing.

The characteristic parameter that is recognized by the characteristic parameter recognizing means may be a characteristic parameter relating to how a main object is laid in the selected image. The characteristic parameter recognizing means calculates a circumscribed rectangle of the main object, and that the setting means sets, as one of the target values, an image margin that is based on the calculated circumscribed rectangle. The recognizing means recognizes different image data for respective characteristic parameters, as the selected image data, or different numbers of image data for respective characteristic parameters, as sets of selected image data. The recognizing means recognizes, as the selected image data, from the plurality of image data displayed, image data that is selected through an input device by a user as being close to an image the user imagines.

On the other hand, the invention can also be expressed in a method category. That is, an image processing method according to another aspect of the invention includes the steps of reading out a plurality of image data from storing means and displaying the plurality of image data on a user terminal; recognizing selection, through the user terminal, of image data as a target of image processing among the plurality of image data displayed; extracting a characteristic parameter of the image data the selection of which through the user terminal has been recognized; and setting a target value of image processing to be performed on another image data on the basis of the extracted characteristic parameter, and storing the target value in a memory.

In the image processing method, the step of displaying the plurality of image data displays, together with the plurality of image data, guide information for selection of target image data through the user terminal. The step of recognizing selection through the user terminal recognizes selection of one or a plurality of image data for each characteristic parameter to be extracted. The extracted characteristic parameter is a geometrical characteristic parameter and/or an image quality characteristic parameter of a main object. The geometrical characteristic parameter may be a characteristic parameter relating to how a main object is laid in the selection-recognized image.

The invention can also be expressed as a program to be executed by a computer. That is, a program according to another aspect of the invention causes a computer to perform functions of reading out a plurality of image data from storing means and displaying the plurality of image data on a user terminal; recognizing selection, through the user terminal, of image data as a target of image processing among the plurality of image data displayed; extracting a characteristic parameter of the image data the selection of which through the user terminal has been recognized; setting a target value of image processing to be performed on another image data on the basis of the extracted characteristic parameter, and storing the target value in a memory; and performing image processing on a prescribed image data using the target value that has been set and stored in the memory.

The target value that is set and stored in the memory is a correction parameter that is calculated from the selection-recognized image data, and that the function of performing image processing performs image processing on the prescribed image data using the correction parameter that has been calculated and stored in the memory.

According to the invention, a correction value can be determined on the basis of an image (image data) that gives a user an impression he or she desires. In particular, in displaying or printing a plurality of images, unified images can be obtained on the basis of a selected image.

Although the present invention has been shown and described with reference to a specific embodiment, various changes and modifications will be apparent to those skilled in the art from the teachings herein. Such changes and modifications as are obvious are deemed to come within the spirit, scope and contemplation of the invention as defined in the appended claims.

1. An image processing apparatus comprising:
characteristic parameter recognizing unit that recognizes a characteristic parameter of selected image data from the selected image data that is selected by a user; and
an image processing unit that performs image processing on a plurality of image data individually using, as one of target values, the characteristic parameter of the selected image data that is recognized by the characteristic parameter recognizing unit.

2. The image processing apparatus according to claim 1, wherein the selected image data is one or more of the plurality of image data.

3. The image processing apparatus according to claim 1, further comprising a storage unit that stores the plurality of image data.

4. The image processing apparatus according to claim 1, wherein the characteristic parameter recognizing unit provides sample images to a user terminal connected to the image processing apparatus and the selected image data is selected according to an input made by the user through the user terminal.

5. The image processing apparatus according to claim 1, wherein the characteristic parameter recognizing unit recognizes a geometrical characteristic parameter of one or more of the selected image data as the characteristic parameter.

6. The image processing apparatus according to claim 1, wherein the characteristic parameter recognizing unit recognizes, as the characteristic parameter, an image quality characteristic parameter including at least one of brightness, contrast, saturation, hue, and a resolution of one or more of the selected image data.

7. An image processing apparatus comprising:
a displaying unit that displays a plurality of image data in a listed form;
a recognizing unit that recognizes, as selected image data, one or more of the plurality of image data displayed by the displaying unit;
a characteristic parameter recognizing unit that recognizes a characteristic parameter of the selected image data from the selected image data that is recognized by the recognizing unit; and
a setting unit that sets the characteristic parameter recognized by the characteristic parameter recognizing unit, as one of target values of image correction processing on the image data to be subjected to image processing.

8. The image processing apparatus according to claim 7, wherein the characteristic parameter recognizing unit recognizes, as the characteristic parameter, a characteristic parameter relating to how a main object in the selected image is laid in the selected image data.

9. The image processing apparatus according to claim 8, wherein the characteristic parameter recognizing unit calculates a circumscribed rectangle of the main object, and
wherein the setting unit sets, as one of the target values, an image margin based on the calculated circumscribed rectangle.

10. The image processing apparatus according to claim 7, wherein the recognizing unit recognizes different image data for each of a plurality of the characteristic is parameters, as the selected image data.

11. The image processing apparatus according to claim 10, wherein that the recognizing unit recognizes different numbers of image data for each of a plurality of the characteristic parameters, as sets of selected image data.

12. The image processing apparatus according to claim 7, wherein the recognizing unit recognizes, as the selected image data, from the plurality of image data displayed, image data that is selected by a user as being close to an image the user imagines.

13. An image processing method comprising:
displaying on a user terminal a plurality of image data read out from a storing unit;
recognizing a selection made by a user through the user terminal, the selection of image data as a target image data of image processing among the plurality of image data displayed;
extracting a characteristic parameter of the selected image data;
setting a target value of the image processing to be performed on other image data on the basis of the extracted characteristic parameter; and
storing the target value in a storage unit.

14. The image processing method according to claim 13, wherein in displaying the plurality of image, guide information that provides a guide for the selection of the target image data is displayed on the user terminal.

15. The image processing method according to claim 13, wherein in recognizing the selection, a selection of one or more of image data for each characteristic parameter to be extracted is recognized.

16. The image processing method according to claim 13, wherein the extracted characteristic parameter includes a geometrical characteristic parameter of a main object in the selected image data.

17. The image processing method according to claim 13, wherein the extracted characteristic parameter includes an image quality characteristic parameter of a main object in the selected image data.

18. The image processing method according to claim 16, wherein the geometrical characteristic parameter is a characteristic parameter relating to how a main object in the selected image is laid in the selected image data.

19. An image processing program product for causing a computer to execute procedures comprising:
displaying on a user terminal a plurality of image data read out from a storing unit;
recognizing a selection made by a user through the user terminal, the selection of image data as a target image data of image processing among the plurality of image data displayed;
extracting a characteristic parameter of the selected image data;
setting a target value of the image processing to be performed on other image data on the basis of the extracted characteristic parameter; and
storing the target value in a storage unit.

20. The image processing program product according to claim 19, further causing the computer to execute performing an image processing on an image data using the target value that has been set and stored in the storage unit.

21. The image processing program product according to claim 20, wherein the target value that is set and stored in the storage unit is a correction parameter that is calculated from the selected image data, and
wherein in the image processing is performed on the image data using the correction parameter.
